(19) United States
(12) Patent Application Publication
(10) Pub. No.: US 2010/0060106 A1
(43) Pub. Date: Mar. 11, 2010

(54) Linear planar servomotor with spare-mover standby area

(75) Inventors: Chien-Cheng Lin, Taichung City (TW); Po-Chin Su., Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/283,227

(22) Filed: Sep. 10, 2008

(51) Int. Cl. H02N 2/08

(52) U.S. Cl. 310/323.05

(57) ABSTRACT

A linear planar servomotor having at least one spare-mover standby area is characterized in at least one spare-mover receiving element attached to an edge of a planar stator of the linear planar servomotor for providing an upper surface of the spare-mover receiving element as the spare-mover standby area, wherein the spare-mover standby area is level with an upper surface of the stator. Thus, at least one spare mover of the linear planar servomotor can be placed on the spare-mover standby area for immediately replacing a working mover on the planar stator of the linear planar servomotor.

### BACKGROUND OF THE INVENTION

1. Technical Field

The present invention relates to linear planar servomotors, and more particularly, to a linear planar servomotor equipped with at least one spare-mover standby area.

2. Description of Related Art

It is known in the art that linear planar servomotors are typically used in precise processing applications, such as wafer manufacturing in semiconductor industry. Such a linear planar servomotor achieves liner travel control by controlling movers to move on a planar stator thereof. For customizing linear planar servomotors that meet various specifications that users request, one linear planar servomotor may be equipped with one or more movers or even a variable number of movers. Conventionally, when the number of the movers on a linear planar servomotor has to be changed, it is necessary to stop the linear planar servomotor and then add or remove the movers, rendering interrupted manufacturing process. On the other hand, when the linear planar servomotor involves two or more manufacturing or measuring processes, the linear planar servomotor has to conduct the first process and then is stopped to get tools thereon changed for the successive process, rendering reduced processing efficiency. In current applications, such linear planar servomotors are mainly operated 7-24 for the semiconductor industry. Once movers are broken and need to be replaced or repaired, the linear planar servomotors has to be shut off for a time period for mover replacing or repairing, and such breach of the manufacturing process can cause significant economical loss.

In view of the aforementioned problem, a prior art device as shown in FIG. 1 is developed basing on a conventional linear planar servomotor 80 that has four movers 82 on a planar stator 81 thereof, as shown in FIG. 1. However, as can be seen in FIG. 2, a linear planar servomotor 90 provided with spare movers 93 obviously needs an enlarged area of a planar stator 91 to receive the spare movers 93 in addition to working movers 92. Therefore, the prior art device causes wasted areas 94 of the planar stator and increases space consumption as well as equipment costs.

### SUMMARY OF THE INVENTION

To further improve the prior art, one objective of the present invention is to provide a linear planar servomotor with at least one spare-mover standby area that receives an additional mover of the linear planar servomotor not in use so as to allow a number of movers of the linear planar servomotor to be easily changed during operation without shutting off the linear planar servomotor.

Another objective of the present invention is to provide a linear planar servomotor with at least one spare-mover standby area that receives a mover for a successive process different from a current process so that the mover can be directly provided to the linear planar servomotor when the current process is finished without shutting off the linear planar servomotor, thereby saving time for replacing movers for different processes.

Another objective of the present invention is to provide a linear planar servomotor with at least one spare-mover standby area that receives a spear mover so that when any of working movers malfunctions, the spear mover can replace the broken working movers immediately without shutting off the linear planar servomotor, thereby saving time for stopping and restarting the linear planar servomotor.

Another objective of the present invention is to provide a linear planar servomotor with at least one spare-mover standby area that is provided by a separate element affixed to the linear planar servomotor so that no additional area of a planar stator of the linear planar servomotor is required for receiving additional movers or spear movers, thereby saving costs for the stator.

To achieve these and other objectives of the present invention, the disclosed linear planar servomotor is equipped with at least one spare-mover receiving element at an edge of a planar stator thereof for providing an upper surface of the spare-mover receiving element as a standby area, wherein the upper surface of the spare-mover receiving element is level with the stator.

According to one aspect of the present invention, the spare-mover receiving element is affixed to the linear planar servomotor by at least one fastener.

According to one aspect of the present invention, the spare-mover receiving element comprises the upper surface acting as the standby area and a lateral surface that is such affixed to the linear planar servomotor by at least one fastener that the upper surface of the spare-mover receiving element is level with the stator.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a conventional linear planar servomotor;

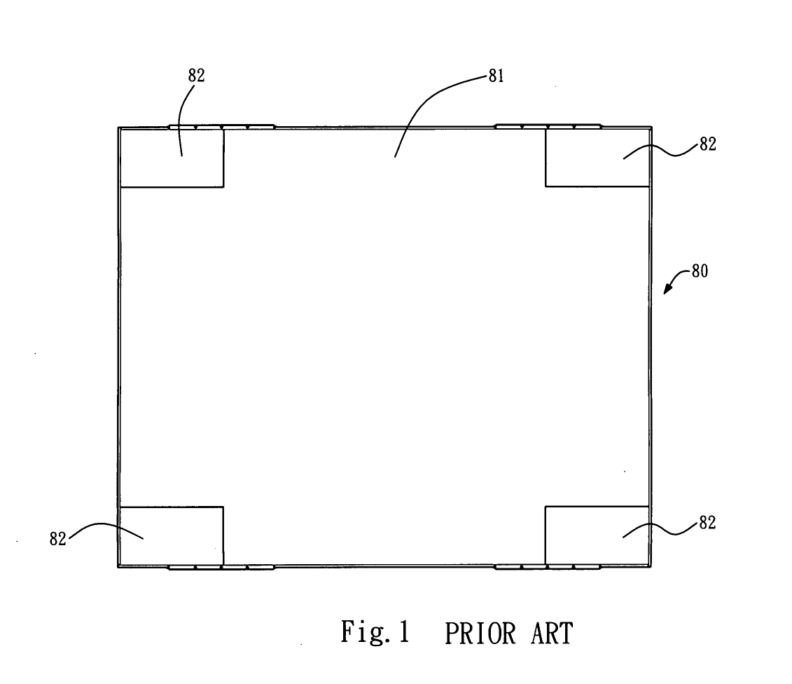

FIG. 2 is another known linear planar servomotor having a plurality of spare movers;

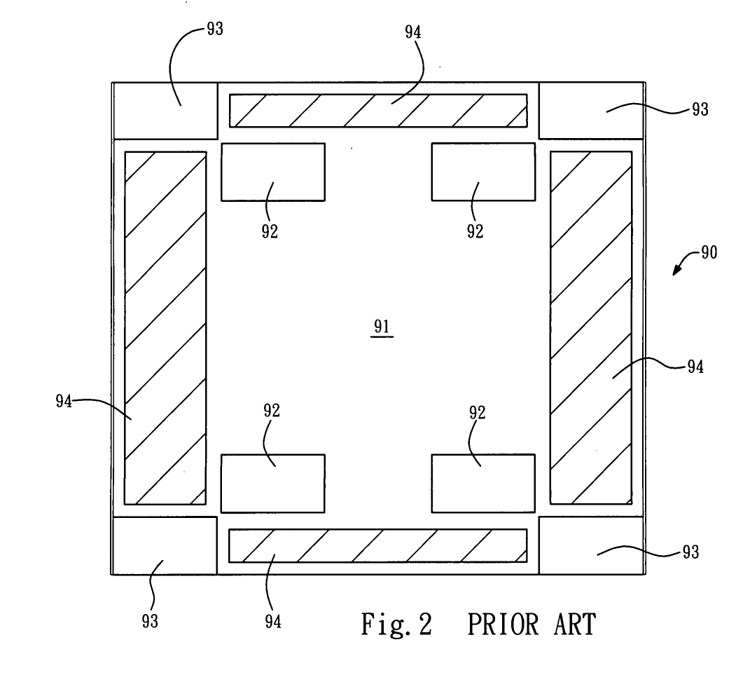

FIG. 3 is schematic drawing showing spare-mover receiving elements assembled to a linear planar servomotor according to the present invention;

FIG. 4 is an applied view of the linear planar servomotor having four spare-mover standby areas according to the present invention; and

FIG. 5 is a top view of FIG. 4.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

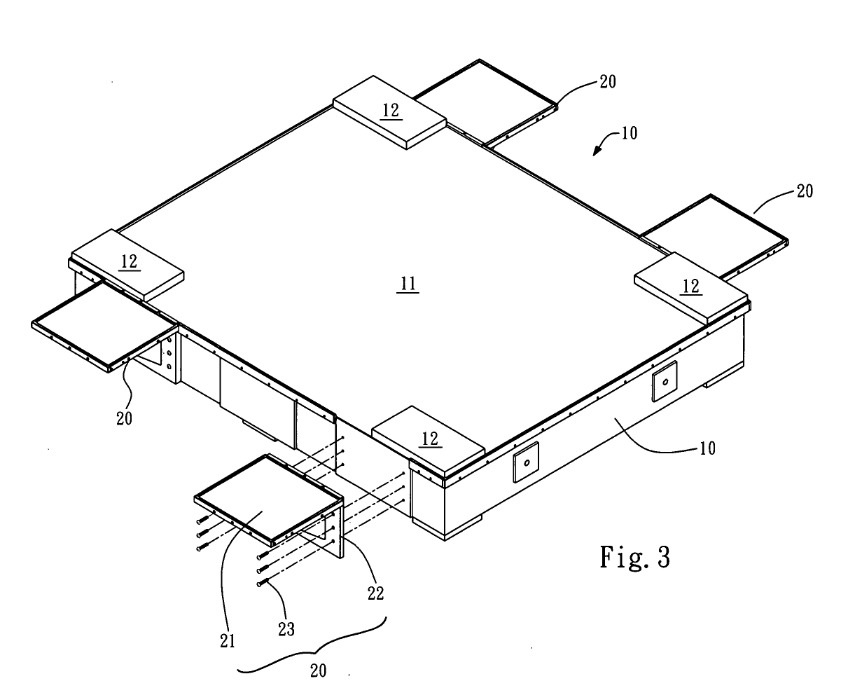

According to the present invention, a linear planar servomotor 10 is attached by plural spare-mover receiving elements 20 at a planar stator 11 thereof. Referring to FIGS. 3 to 5, the linear planar servomotor 10 comprises four working movers 12 and accordingly equipped with four said spare-mover receiving elements 20. However, in another embodiment, a number of the spare-mover receiving elements 20 can be varied according to practical needs and is not necessarily equal to a number of the working movers 12 of the linear planar servomotor 10.

As can be seen in FIG. 3, each of the spare-mover receiving elements 20 comprises an upper surface acting as a spare-mover standby area 21 and a lateral surface acting as a fastening surface 22 so as to have an L-shaped sectional contour. Therein, the fastening surface 22 is formed with a plurality of holes that allow a plurality of fasteners 23 to pass therethrough so as to affix the spare-mover receiving element 20 to the linear planar servomotor 10 in the manner that the spare-mover standby area 21 of the spare-mover receiving element 20 is level with an upper surface of the planar stator 11 of the linear planar servomotor 10.

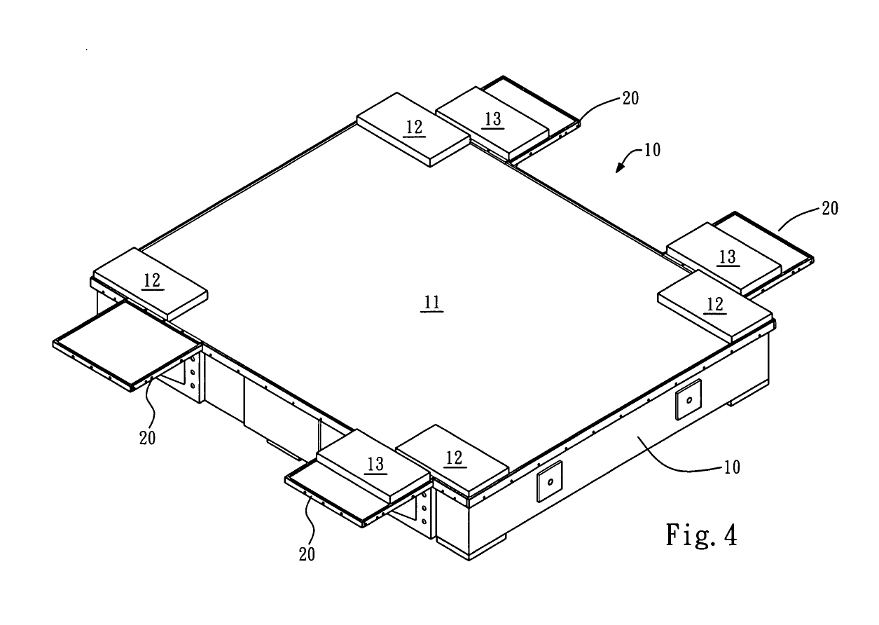

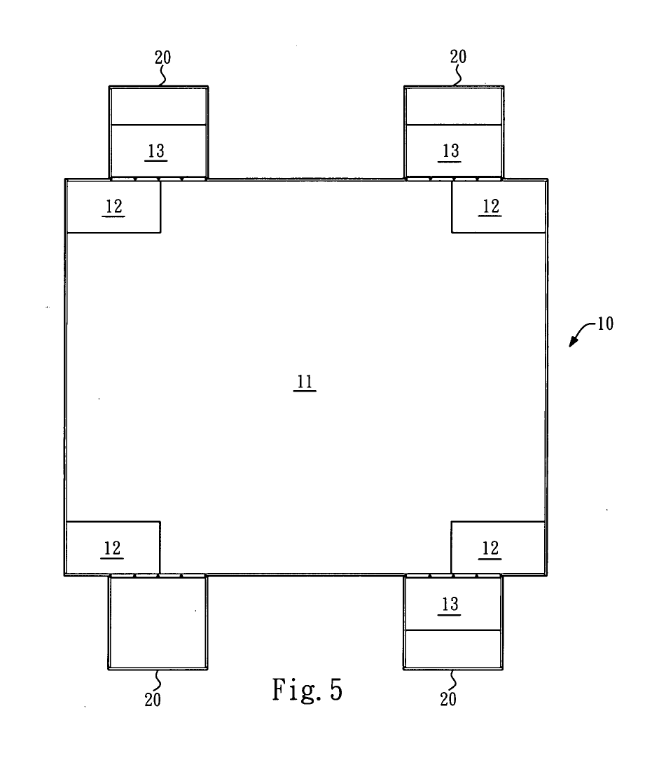

Therefore, as shown in FIGS. 4 and 5, a plurality of spare movers 13 can be placed on the spare-mover standby areas 21 (as labeled in FIG. 3) provided by the spare-mover receiving elements 20 so that when any of the working movers 12 malfunctions or when the linear planar servomotor 10 is about to be implemented for a different process, the spare movers 13 can immediately supersede the working movers 12 to be replaced.

According to the aforementioned structure, the spare-mover standby areas 21 allows the linear planar servomotor 10 to change the number of movers it required according to a user's needs and allows movers not in use to be stored at the spare-mover standby areas 21 provided by the spare-mover receiving elements 20. Thereby, the linear planar servomotor 10 can work with the variable number of movers and needs not to be shut off for replacing, adding or removing the movers.

Besides, when the linear planar servomotor 10 is used for two or more processes, the presently needed working movers 12 can be placed on the planar stator 11 and other standby movers 13 required by a later process can be placed on the spare-mover standby areas 21 provided by the spare-mover receiving elements 20. After the first process is finished, the standby movers 13 on the spare-mover standby areas 21 provided by the spare-mover receiving elements 20 can directly enter the planar stator 11 to replace the working movers 12 and the retired working movers 12 can be placed on the spare-mover standby areas 21 provided by the spare-mover receiving elements 20. Thereby, the linear planar servomotor 10 can work with the movers of different functions and needs not to be shut off for replacing the movers.

Meanwhile, the spare-mover receiving elements 20 may also receive some spare movers 13 so that when any of the working movers 12 malfunctions, the spare mover 13 can immediately enter the planar stator 11 and fill the vacant position of the broken working mover 12, without shutting off the linear planar servomotor 10.

In addition, since the spare-mover receiving elements 20 are fastened to the linear planar servomotor 10, there is no need to increase an area of the planar stator for receiving the additional or spare movers 13, thereby saving space and saving money that is otherwise needed for making an enlarged stator.

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A linear planar servomotor having at least one spare-mover standby area, being characterized in having at least one spare-mover receiving element attached to an edge of a planar stator of the linear planar servomotor for providing an upper surface of the spare-mover receiving element as the spare-mover standby area, wherein the spare-mover standby area is level with an upper surface of the planar stator.

2. The linear planar servomotor of claim 1, wherein the spare-mover receiving element is affixed to the linear planar servomotor by at least one fastener.

3. The linear planar servomotor of claim 1, wherein the spare-mover receiving element comprises the upper surface acting as the spare-mover standby area and a lateral surface acting as a fastening surface so that the fastening surface is such affixed to the linear planar servomotor by least one fastener that the spare-mover standby area provided by the spare-mover receiving element is level with the upper surface of the planar stator of the linear planar servomotor.
